(19) United States
(12) Patent Application Publication
(10) Pub. No.: US 2026/0066577 A1
(43) Pub. Date: Mar. 5, 2026

(54) CONNECTION DEVICE

(71) Applicant: Molex, LLC, Lisle, IL (US)

(72) Inventors: Che-Yuan Yang, New Taipei City (TW); Wen-Chih Chen, New Taipei City (TW)

(21) Appl. No.: 19/305,813

(22) Filed: Aug. 21, 2025

(30) Foreign Application Priority Data
Sep. 3, 2024 (CN) 202411227096.5

(51) Int. Cl. H01R 13/533

(52) U.S. Cl. CPC H01R 13/533

(57) ABSTRACT

A connection device includes a connector assembly and a heat sink assembly. The connector assembly includes an inserting passageway which allows a pluggable assembly to insert therein along an inserting direction. The heat sink assembly is provided outside the connector assembly and includes a cold plate and a slidable mechanism. The cold plate has a main body and a heat dissipating base. The main body is used to allow a cooling liquid to flow in an interior of the main body. The heat dissipating base is capable of floating relative to the main body and is used to thermally engage with the pluggable assembly. The slidable mechanism is movably provided to the cold plate, and a part of the slidable mechanism extends into the inserting passageway and is capable of allowing the pluggable assembly to push. In a process that the pluggable assembly inserts into the inserting passageway, the slidable mechanism is pushed and moved by the pluggable assembly to bring the heat dissipating base to move so that the heat dissipating base converts from a state that the heat dissipating base is spaced apart from the pluggable assembly to a state that the heat dissipating base contacts the pluggable assembly.

### TECHNICAL FIELD

The present invention relates to a connection device, and particularly relates to a connection device which allows a pluggable assembly to mate therewith.

### BACKGROUND

A general connection device includes a connector assembly which allows a pluggable assembly to mate therewith and a heat sink assembly which is mounted to the connector assembly. The heat sink assembly is used to thermally engage with the pluggable assembly which is inserted into the connector assembly, so that heat energy generated in operation of the pluggable assembly can be conducted to the external, thus an effect of heat dissipating is attained, however, in a process that the pluggable assembly is inserted into the connector assembly or is pulled out from the connector assembly, there would be friction between the pluggable assembly and the heat sink assembly, a thermal interface material on a surface of the heat sink assembly would be scratched, which results in damage to the heat sink assembly. In another aspect, the connector assembly of the general connection device usually employs a metal shell to act as an electro-magnetic shielding cage, and the heat sink assembly (for example a cold plate) usually has a certain weight and is mounted above the metal shell, which results in that the connector assembly is easily damaged or deformed, and even that the heat sink assembly cannot be effectively fixed to the connector assembly.

### SUMMARY

Therefore, an object of the present invention is to provide a connection device which can solve at least one aforementioned problem.

Accordingly, a connection device of the present invention comprises a connector assembly and a heat sink assembly. The connector assembly comprises an inserting passageway which allows a pluggable assembly to insert therein along an inserting direction. The heat sink assembly is provided outside the connector assembly and comprises a cold plate and a slidable mechanism. The cold plate has a main body and a heat dissipating base. The main body is used to allow a cooling liquid to flow in an interior of the main body. The heat dissipating base is capable of floating relative to the main body and is used to thermally engage with the pluggable assembly. The slidable mechanism is movably provided to the cold plate, and a part of the slidable mechanism extends into the inserting passageway and is capable of allowing the pluggable assembly to push. In a process that the pluggable assembly inserts into the inserting passageway, the slidable mechanism is pushed and moved by the pluggable assembly to bring the heat dissipating base to move so that the heat dissipating base converts from a state that the heat dissipating base is spaced apart from the pluggable assembly to a state that the heat dissipating base contacts the pluggable assembly.

In some embodiments, two sides of a bottom of the heat dissipating base which each extend along the inserting direction each are provided with a recessed portion; the slidable mechanism comprises two actuating members which are movably provided to the cold plate, each actuating member has a protruding portion which extends toward the heat dissipating base and a contacting portion which extends into the inserting passageway and is capable of allowing the pluggable assembly to push.

In some embodiments, when the contacting portions of the two actuating members of the slidable mechanism are not pushed by the pluggable assembly, the protruding portions of the two actuating members of the slidable mechanism push up the two sides of the bottom of the heat dissipating base, which each extend along the inserting direction, to make the heat dissipating base spaced apart from the pluggable assembly; when the contacting portions of the two actuating members of the slidable mechanism are pushed and moved by the pluggable assembly, the protruding portions of the two actuating members respectively move into the two recessed portions of the heat dissipating base, which brings the heat dissipating base to move toward the inserting passageway so that the heat dissipating base contacts the pluggable assembly.

In some embodiments, the slidable mechanism further comprises two elastic members which are capable of respectively allowing the two actuating members to press thereagainst so that the two elastic members are compressed, when the contacting portions of the two actuating members of the slidable mechanism are pushed and moved by the pluggable assembly, the two actuating members of the slidable mechanism move along the inserting direction to respectively compress the two elastic members; when the pluggable assembly is pulled out from the inserting passageway, the two elastic members are released to restore lengths thereof to respectively bring the two actuating members to move along a direction opposite to the inserting direction.

In some embodiments, the heat sink assembly further comprises two position-limiting members which are provided to a bottom surface of the main body, each actuating member further has a movable hole which passes through an upper surface and a lower surface of the actuating member and extends along the inserting direction, the movable holes of the two actuating members respectively allow the two position-limiting members to pass therethrough in a manner that the two position-limiting members are capable of respectively moving relative to the movable holes in the inserting direction.

In some embodiments, the two sides of a bottom of the heat dissipating base which each extend along the inserting direction each are provided with two recessed portions are arranged along the inserting direction; the slidable mechanism comprises two actuating members which are movably provided to the cold plate, each actuating member has two protruding portions which extend toward the heat dissipating base and are arranged along the inserting direction, and a contacting portion which extends into the inserting passageway and is capable of allowing the pluggable assembly to push, when the contacting portions of the two actuating members of the slidable mechanism are not pushed by the pluggable assembly, the four protruding portions of the two actuating members of the slidable mechanism respectively push up four positions of the bottom of the heat dissipating base to make the heat dissipating base spaced apart from the pluggable assembly; when the contacting portions of the two actuating members of the slidable mechanism are pushed and moved by the pluggable assembly, the two protruding portions of the two actuating members respectively move into the four recessed portions of the heat dissipating base, which brings the heat dissipating base to move toward the inserting passageway so that the heat dissipating base contacts the pluggable assembly.

A connection device of the present invention comprises a connector assembly and a heat sink assembly. The connector assembly comprises an inserting passageway which allows a pluggable assembly to insert therein along an inserting direction. The heat sink assembly is provided outside the connector assembly and comprises a heat dissipating base and a slidable mechanism. The heat dissipating base is used to thermally engage with the pluggable assembly. The slidable mechanism is movably provided to the heat sink assembly, and a part of the slidable mechanism extends into the inserting passageway and is capable of allowing the pluggable assembly to push, in a process that the pluggable assembly inserts into the inserting passageway, the slidable mechanism is pushed and moved by the pluggable assembly to bring the heat dissipating base to move so that the heat dissipating base converts from a state that the heat dissipating base is spaced apart from the pluggable assembly to a state that the heat dissipating base contacts the pluggable assembly.

In some embodiments, two sides of a bottom of the heat dissipating base which each extend along the inserting direction each are provided with a recessed portion; the slidable mechanism comprises two actuating members which are movably provided to the heat sink assembly, each actuating member has a protruding portion which extends toward the heat dissipating base and a contacting portion which extends into the inserting passageway and is capable of allowing the pluggable assembly to push.

In some embodiments, when the contacting portions of the two actuating members of the slidable mechanism are not pushed by the pluggable assembly, the protruding portions of the two actuating members of the slidable mechanism push up the two sides of the bottom of the heat dissipating base, which each extend along the inserting direction, to make the heat dissipating base spaced apart from the pluggable assembly; when the contacting portions of the two actuating members of the slidable mechanism are pushed and moved by the pluggable assembly, the protruding portions of the two actuating members respectively move into the two recessed portions of the heat dissipating base, which brings the heat dissipating base to move toward the inserting passageway so that the heat dissipating base contacts the pluggable assembly.

In some embodiments, the slidable mechanism further comprises two elastic members which are capable of respectively allowing the two actuating members to press thereagainst so that the two clastic members are compressed, when the contacting portions of the two actuating members of the slidable mechanism are pushed and moved by the pluggable assembly, the two actuating members of the slidable mechanism move along the inserting direction to respectively compress the two elastic members; when the pluggable assembly is pulled out from the inserting passageway, the two elastic members are released to restore lengths thereof to respectively bring the two actuating members to move along a direction opposite to the inserting direction.

In some embodiments, the heat sink assembly further comprises two position-limiting members which are provided to the heat sink assembly, each actuating member further has a movable hole which passes through an upper surface and a lower surface of the actuating member and extends along the inserting direction, the movable holes of the two actuating members respectively allow the two position-limiting members to pass therethrough in a manner that the two position-limiting members are capable of respectively moving relative to the movable holes in the inserting direction.

In some embodiments, the two sides of a bottom of the heat dissipating base which each extend along the inserting direction each are provided with two recessed portions are arranged along the inserting direction; each actuating member has two protruding portions which extend toward the heat dissipating base and are arranged along the inserting direction, and a contacting portion which extends into the inserting passageway and is capable of allowing the pluggable assembly to push, when the contacting portions of the two actuating members of the slidable mechanism are not pushed by the pluggable assembly, the four protruding portions of the two actuating members of the slidable mechanism respectively push up four positions of the bottom of the heat dissipating base to make the heat dissipating base spaced apart from the pluggable assembly; when the contacting portions of the two actuating members of the slidable mechanism are pushed and moved by the pluggable assembly, the two protruding portions of the two actuating members are respectively moved into the four recessed portions of the heat sink assembly, which brings the heat sink assembly to move toward the inserting passageway so that the heat sink assembly contacts the pluggable assembly.

A connection device of the present invention comprises a connector assembly, a cold plate and a bracket. The connector assembly comprises a metal shell. The metal shell provides an inserting passageway which allows a pluggable assembly to insert therein along an inserting direction. The cold plate is positioned above the connector assembly and is used to thermally engage with the pluggable assembly. The bracket is mounted to the metal shell and is used to support the cold plate, a top portion of the bracket and a top portion of the metal shell together defines a receiving space. The receiving space allows the cold plate to be placed therein.

In some embodiments, a material of the bracket is an electrical conductive metal or an insulative plastic.

In some embodiments, the connector assembly further comprises an electro-magnetic shielding gasket which is positioned on a front side of the metal shell, the bracket contacts the electro-magnetic shielding gasket, and a material of the bracket is a metal or a plastic plated with an electrical conductive layer, which is electrical conductive.

In some embodiments, the cold plate and the bracket are locked together by screws.

In some embodiments, the connector assembly and the bracket are locked together by screws.

In some embodiments, two sides of the metal shell which each extend along the inserting direction each are formed with multiple joining holes which are recessed from the metal shell; the bracket comprises two bracket side walls which each extend along the inserting direction and a plurality of joining members which are respectively provided to inner sides of the two bracket side walls, the plurality of joining members removably insert into the joining holes respectively so that the bracket is mounted to the connector assembly.

Technical effects of the present invention lay in that: by that the slidable mechanism is movably provided to the cold plate, in a process that the pluggable assembly inserts into the inserting passageway, firstly the heat dissipating base is spaced apart from the pluggable assembly to prevent friction between the heat dissipating base and the pluggable assembly to damage the heat dissipating base, and when the pluggable assembly which inserts into the inserting passageway pushes and moves the slidable mechanism, the heat dissipating base still can thermally engage with the pluggable assembly, in turn an effect of promoting durability is attained. In another aspect, by that the cold plate is fixed to the metal shell via the bracket, a weight per unit area applied to the metal shell by the cold plate can be dispersed, which avoids the metal shell being deformed due to bearing the weight, and by that the receiving space allows the cold plate to be placed therein, the cold plate can be limited by the bracket so that the cold plate cannot move front, rear, left and right, in turn an effect of firmly and effectively fixing is attained. Preferably, the bracket is locked with the cold plate and/or the metal shell by the screws, firmness of the bracket can be promoted.

### BRIEF DESCRIPTION OF THE DRAWINGS

Other features and effects of the present invention will be apparent from an embodiment with reference to the drawings, in which:

FIG. 1 is a perspective view illustrating an implementing manner of an embodiment of a connection device of the present invention and a plurality of pluggable assemblies;

FIG. 2 is a partially exploded view of the embodiment;

FIG. 3 is an exploded perspective view of a cold plate of the embodiment;

FIG. 4 is an exploded perspective view of the cold plate viewed from an angle different from FIG. 3;

FIG. 5 is a perspective view of the embodiment with a circuit board, a bracket, a plurality of screws and an outer cover of the cold plate of the embodiment removed.

FIG. 6 is a perspective view of FIG. 5 viewed from another angle;

FIG. 7 is a locally exploded view of FIG. 5 with a main body, a sealing member and two joints of the cold plate further removed;

FIG. 8 is a local perspective view of FIG. 7 with a plurality of heat dissipating bases of the cold plate further removed;

FIG. 9 is an exploded perspective view illustrating implementing details of a slidable mechanism, position-limiting members and the heat dissipating base of the embodiment;

FIG. 10 is an exploded perspective view of FIG. 9 viewed from another angle;

FIG. 11 is a top view illustrating the implementing manner of the embodiment and the plurality of pluggable assemblies with the circuit board removed;

FIG. 12 is a cross-sectional view along a line XII-XII of FIG. 11;

FIG. 13 is a cross-sectional view along a line XIII-XIII of FIG. 11;

FIG. 14 is an enlarged view of FIG. 13 indicated by a circle F1;

FIG. 15 is a top view similar to FIG. 11 and illustrating an implementing manner of state converting between the embodiment and the pluggable assembly in use with the circuit board removed;

FIG. 16 is a cross-sectional view along a line XVI-XVI of FIG. 15;

FIG. 17 is a local perspective view similar to FIG. 8 illustrating an implementing manner of the slidable mechanism for state converting in use;

FIG. 18 is a cross-sectional view along a line XVIII-XVIII of FIG. 15;

FIG. 19 is an enlarged view of FIG. 18 indicated by a circle F2;

FIG. 20 is a perspective view viewed from another angle and illustrating a connecting relationship among a connector assembly, the bracket and the screws of the embodiment;

FIG. 21 is a perspective view corresponding to a viewing angle of FIG. 20 and illustrating a connecting relationship between the bracket and an electro-magnetic shielding gasket of the connector assembly;

FIG. 22 is an exploded perspective view illustrating implementing details of the bracket, the electro-magnetic shielding gasket and the screws; and

FIG. 23 is an exploded perspective view viewed from an angle different from FIG. 22.

### DETAILED DESCRIPTION

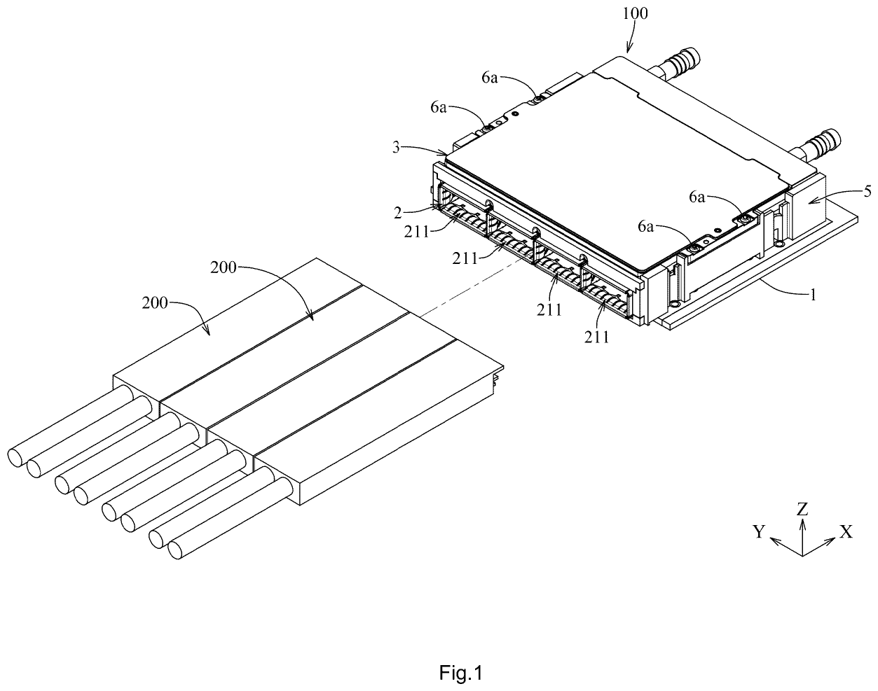

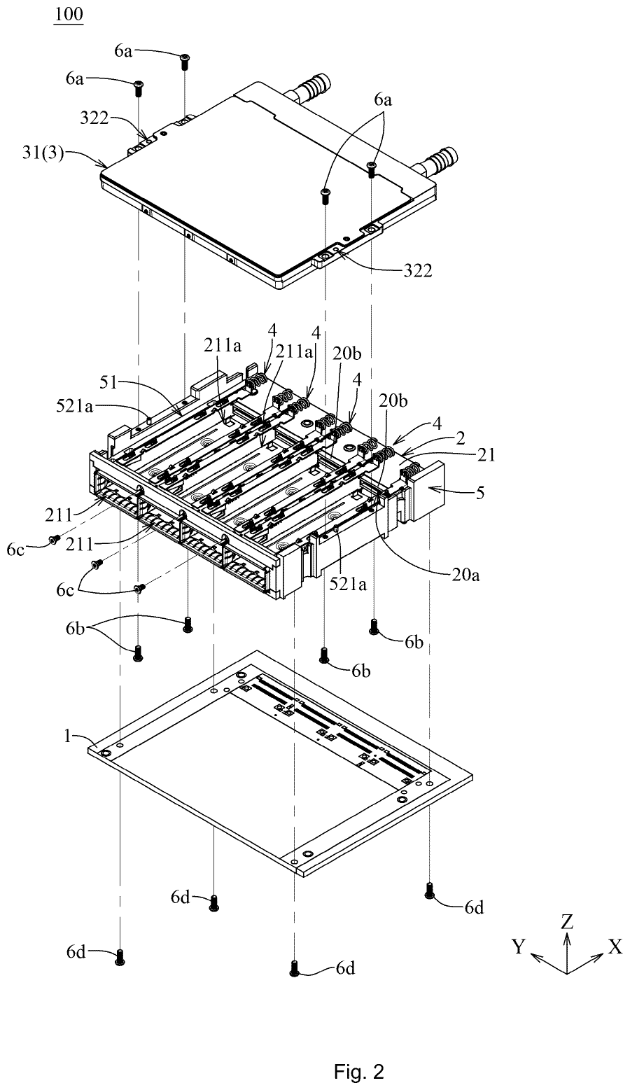

Referring to FIG. 1 and FIG. 2, an embodiment of a connection device 100 of the present invention is illustrated. The connection device 100 is adapted to allow a plurality of pluggable assemblies 200 (here taking four pluggable assemblies 200 as an example) to be electrically connected therewith, and includes a circuit board 1, a connector assembly 2, a heat sink assembly 3, a bracket 5 and a plurality of screws. For sake of convenient description below, directional terms of the connection device 100 are defined in a use circumstance of the connection device 100, that is, in FIG. 1, an arrow of an inserting direction X points to a rear side of the connection device 100, an opposite direction points to a front side of the connection device 100; in FIG. 1, an arrow of an arranging direction Y points to a left side of the connection device 100, an opposite direction points to a right side of the connection device 100; in FIG. 1, an arrow of an up-down direction Z points to an upper side of the connection device 100, an opposite direction points to a lower side of the connection device 100. Moreover, in order to simply the described content, the screws take screws 6a, 6b, 6c, 6d as an example depending on different connecting relationships.

The circuit board 1 is provided with a circuit pattern not shown in the figures, and allows the connector assembly 2 to be provided thereon. The connector assembly 2 is provided with electrical connector components 20b, such as mating slots 20a, terminals (not shown) and the like, but the present invention is not limited thereto, and the connector assembly 2 includes a plurality of inserting passageways 211 (taking four inserting passageways 211 as an example corresponding to the number of the pluggable assemblies 200) which each are opened toward the front and extend along the inserting direction X. The plurality of the inserting passageways 211 are arranged along the arranging direction Y, and respectively allow the plurality of the pluggable assemblies 200 to insert therein along the inserting direction X. Specifically, the connector assembly 2 includes a metal shell 21 which provides the plurality of inserting passageways 211. For example, the metal shell 21 is formed by processing, such as stamping and bending, a metal sheet with a mold, and may be used for electro-magnetic shielding. Each inserting passageway 211 further has a window 211a which is formed to a top surface of the metal shell 21.

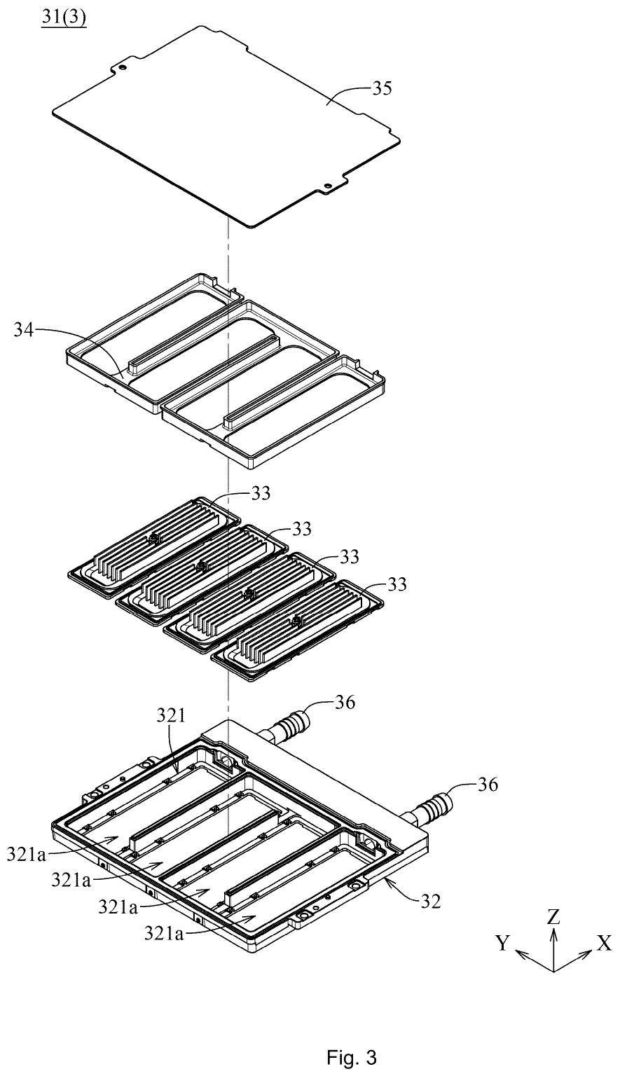

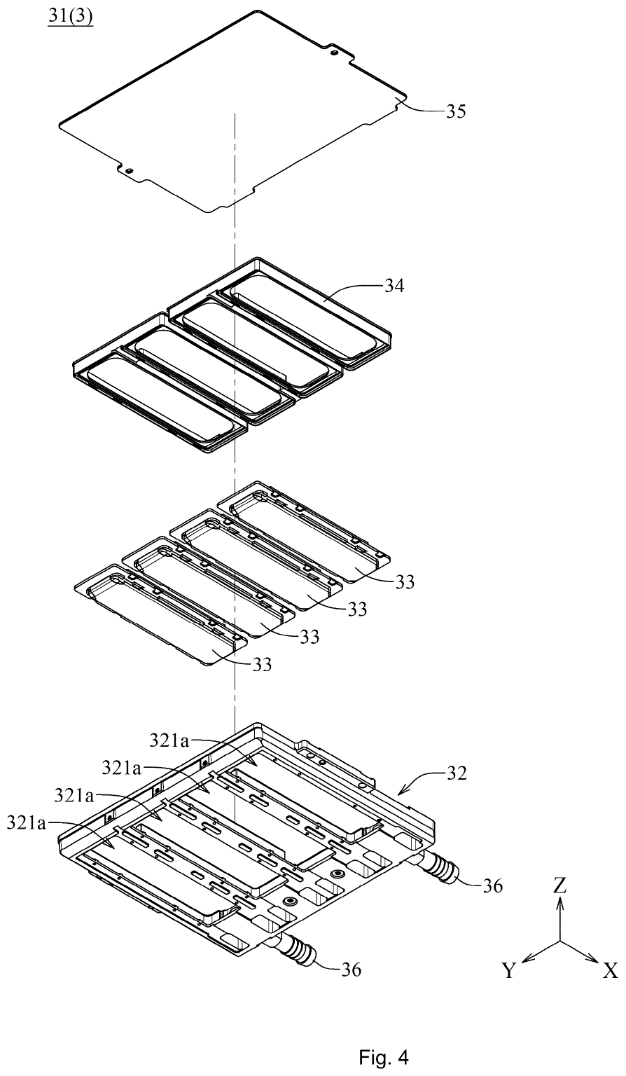

Referring to FIG. 3 to FIG. 5, the heat sink assembly 3 is provided above an exterior of the connector assembly 2, and includes a cold plate 31 and a plurality of slidable mechanisms 4. The cold plate 31 is used to be thermally engage with the plurality of pluggable assemblies 200 (see FIG. 1), which insert into the plurality of inserting passageways 211 respectively, to conduct out heat energy. The cold plate 31 has a main body 32 which extends along the inserting direction X and the arranging direction Y, a plurality of heat dissipating bases 33 (taking four heat dissipating bases 33 as an example corresponding to the number of the inserting passageways 211) which are arranged along the arranging direction Y and the number of which corresponds to the number of the inserting passageways 211, a sealing member 34, an outer cover 35 and two joints 36. An interior of the main body 32 is hollow to form a flow space 321 which extends serpentinely. The flow space 321 is used to allow a cooling liquid to flow therein, and the flow space 321 has a plurality of communicating openings 321a which are formed to a bottom surface of the main body 32 and are arranged along the arranging direction Y. Each communicating openings 321a is aligned with the corresponding windows 211a (see FIG. 2).

The plurality of heat dissipating bases 33 are positioned in the flow space 321 and bottoms of the plurality of heat dissipating bases 33 are respectively provided to the plurality of communicating openings 321a. The sealing member 34 is positioned in the flow space 321, and one side of the sealing member 34 is connected to an inner wall of the flow space 321, the other side of the sealing member 34 is connected to peripheries of the plurality of heat dissipating bases 33 and is separated from the inner wall of the flow space 321, as such, the sealing member 34 and the plurality of heat dissipating bases 33 together seal the plurality of communicating openings 321a respectively, and the plurality of heat dissipating bases 33 may float relative to the main body 32 by means of the sealing member 34, so that the bottoms of the plurality of heat dissipating base 33 are capable of downwardly protruding outside the main body 32 respectively from the plurality of communicating openings 321a.

The outer cover 35 is detachably provided to a top portion of the main body 32 to block an opening on the top portion of the flow space 321. A design that the outer cover 35 is detachable to allow the flow space 321 to be exposed facilitates assembling of the plurality of heat dissipating bases 33 and the main body 32. The two joints 36 are provided side by side in the arranging direction Y, and are respectively positioned to a rear side of the main body 32 and are communicated with the flow space 321 to guide the cooling liquid into the flow space 321 or guide the cooling liquid out from the flow space 321. But in other implementing manners, the heat sink assembly 3 also may be other heat sink which has heat dissipating bases but is not a cold plate type or does not include a cold plate and may float relative to the connector assembly 2, the present invention is not limited to the specific type, and in an implementing manner that a cold plate is not included, the plurality of slidable mechanisms 4 may be provided to other component of the heat sink assembly 3.

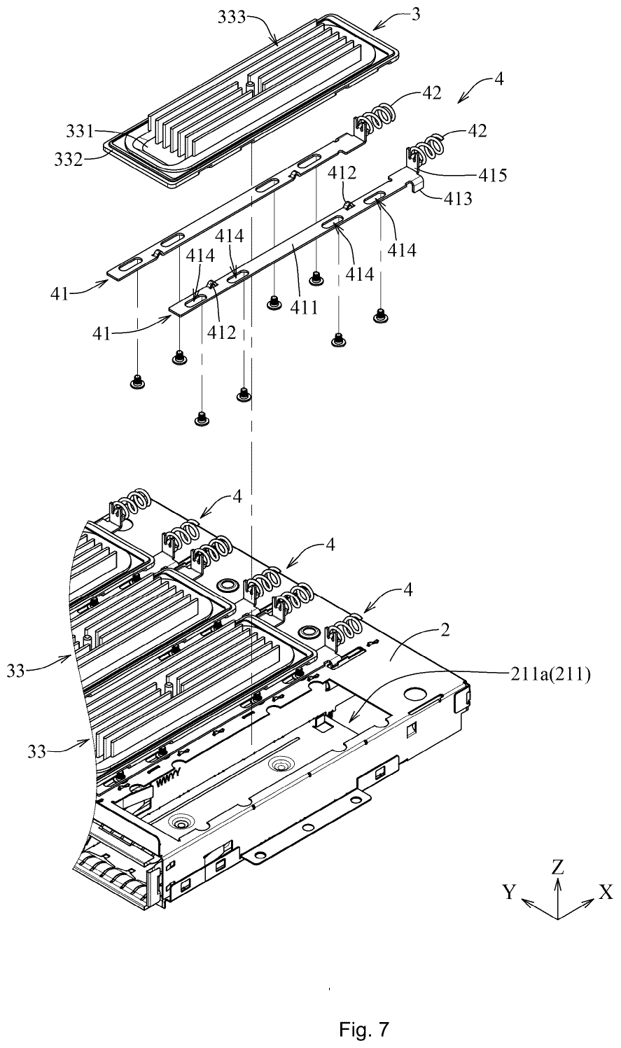

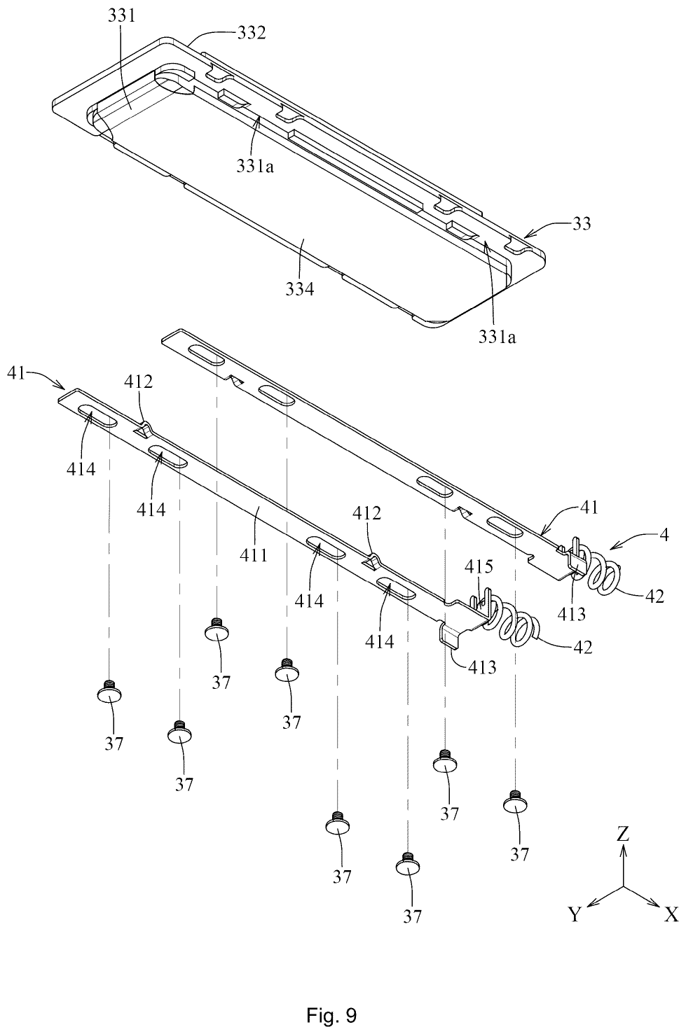

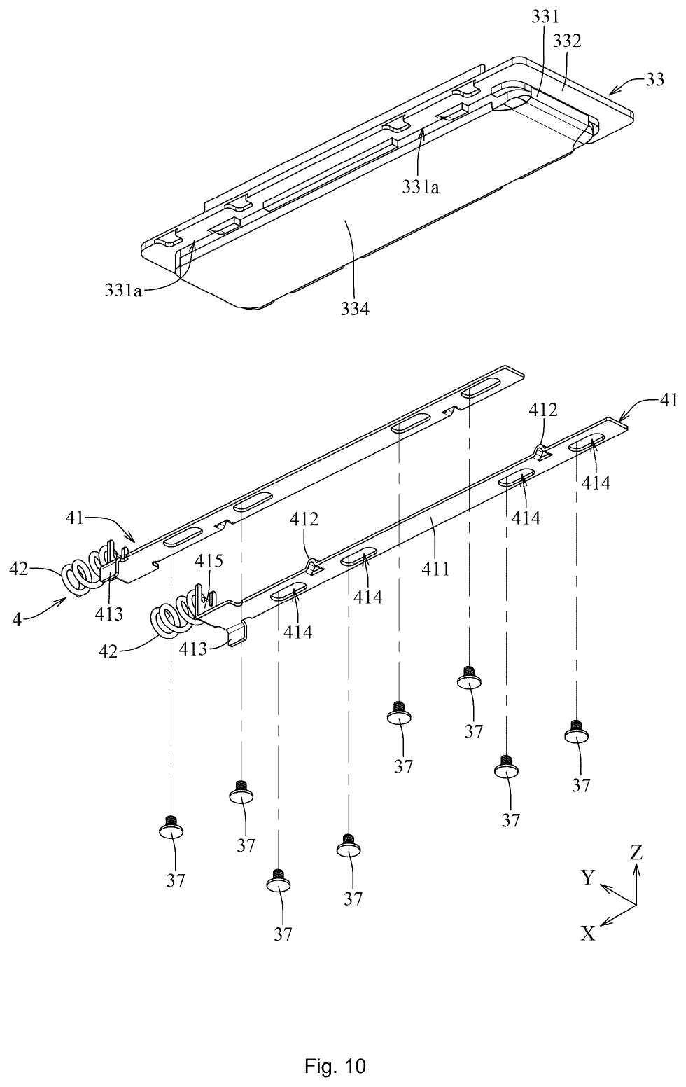

Referring to FIG. 7 to FIG. 10, each heat dissipating base 33 has a heat dissipating main body portion 331 which is rectangular, an edge extending portion 332 which horizontally extends outwardly from a periphery of a top portion of the heat dissipating main body portion 331, a fin portion 333 (see FIG. 7) which is provided to the heat dissipating main body portion 331, and a thermal conductive layer portion 334 which is provided to a bottom surface of the heat dissipating main body portion 331. Two sides of a bottom of the heat dissipating main body portion 331 of each heat dissipating base 33 which extend along the inserting direction X each are provided with multiple recessed portions 331a which are arranged in the inserting direction X. A material of the thermal conductive layer portion 334 is a thermal interface material (TIM).

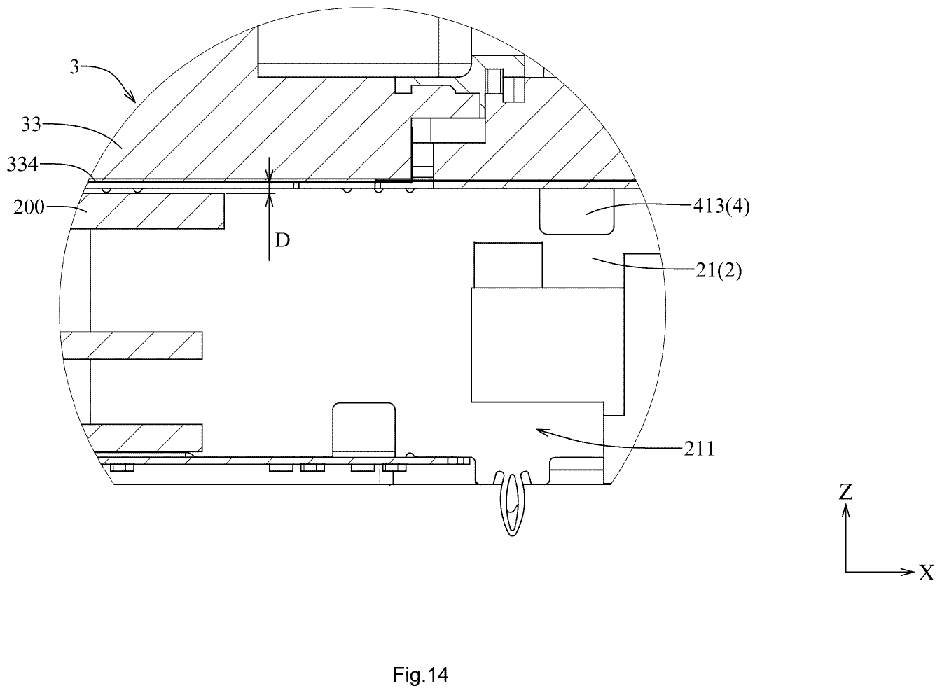

The plurality of slidable mechanisms 4 are movably provided to the main body 32 of the cold plate 31, and a part of each slidable mechanism 4 extends into the corresponding inserting passageway 211 and is capable of allowing the corresponding pluggable assembly 200 (see FIG. 1) to push. Specifically, each slidable mechanism 4 includes two actuating members 41 which are movably provided to a bottom of the main body 32, and two elastic members 42 (for example springs, but the present invention is not limited thereto) which are respectively positioned behind the two actuating members 41. The two actuating members 41 of each slidable mechanism 4 are arranged side by side in the arranging direction Y and are respectively positioned outside two sides of the corresponding window 211a which each extend along the inserting direction X. Each actuating member 41 has an actuating member body portion 411 which extends along the inserting direction X, multiple protruding portions 412 which extend from the actuating member body portion 411 toward the corresponding heat dissipating base 33, a contacting portion 413 which extends downwardly from a rear side of the actuating member body portion 411, multiple movable holes 414 (taking four movable holes 414 as an example, but also may take only one movable hole 414) which pass through an upper surface and a lower surface of the actuating member body portion 411 and are arranged along the inserting direction X, and a pressing portion 415 which extends upwardly from the rear side of the actuating member body portion 411. The multiple protruding portions 412 are arranged in the inserting direction X, and are used to push up the heat dissipating base 33. The contacting portion 413 movably passes through the metal shell 21 in the inserting direction X, and extends into the corresponding inserting passageway 211 and is capable of allowing the corresponding pluggable assembly 200 to push. In a state that the connector assembly 2 is not used (that is, when the pluggable assembly 200 does not insert into the inserting passageway 211 of the connector assembly 2), the heat dissipating base 33 is pushed up by the protruding portions 412 of the slidable mechanism 4 to be retained in state that the heat dissipating base 33 is raised, and be spaced apart from the pluggable assembly 200, a distance D between the heat dissipating base 33 and the pluggable assembly 200 is indicated by two arrows in FIG. 14. In the present embodiment, the number of the slidable mechanisms 4 corresponds to the number of the inserting passageways 211 and the four slidable mechanisms 4 are taken as an example. For sake of convenient description below, an operation between the plurality of slidable mechanisms 4 and the plurality of heat dissipating bases 33 is described only by means of one group of the slidable mechanism 4 and the heat dissipating base 33.

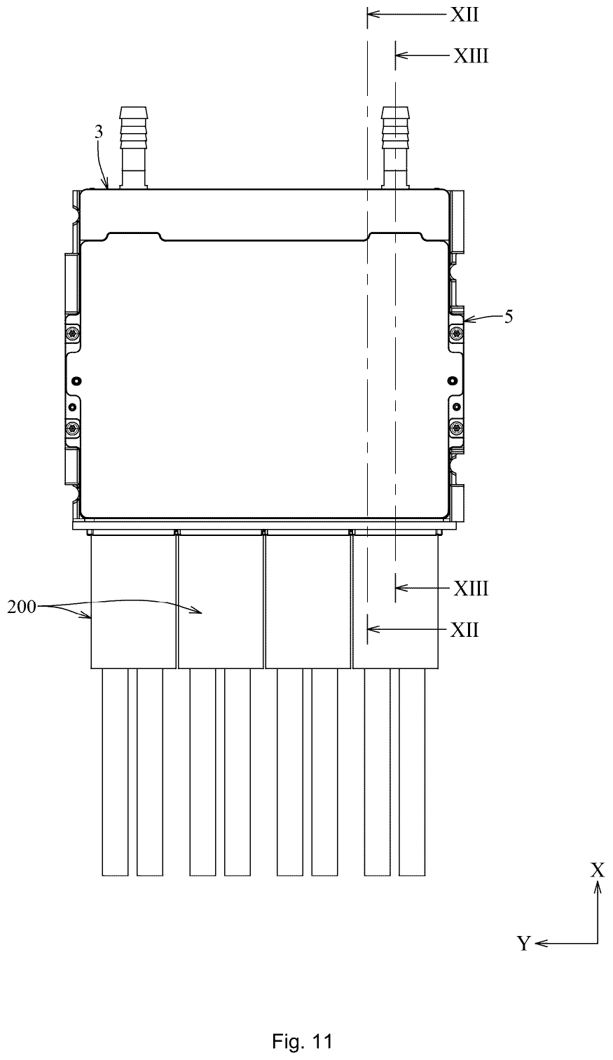

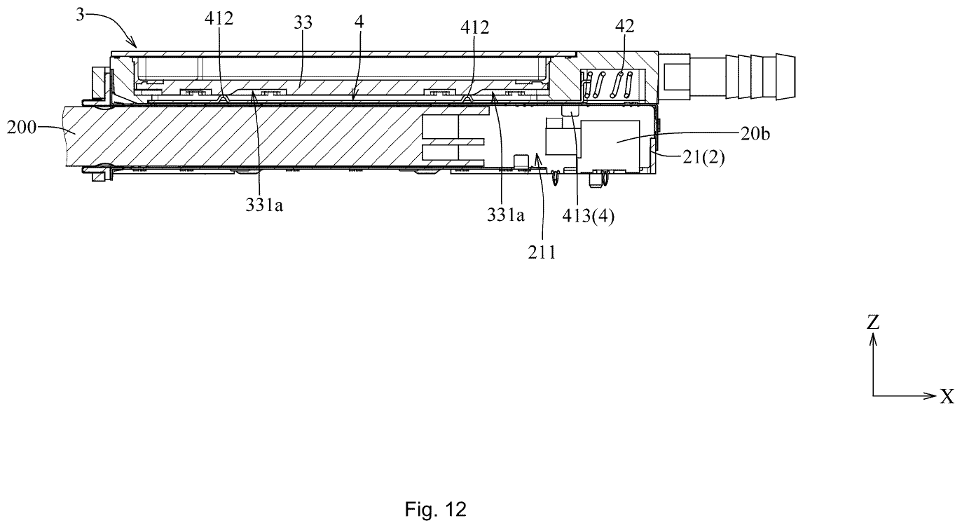

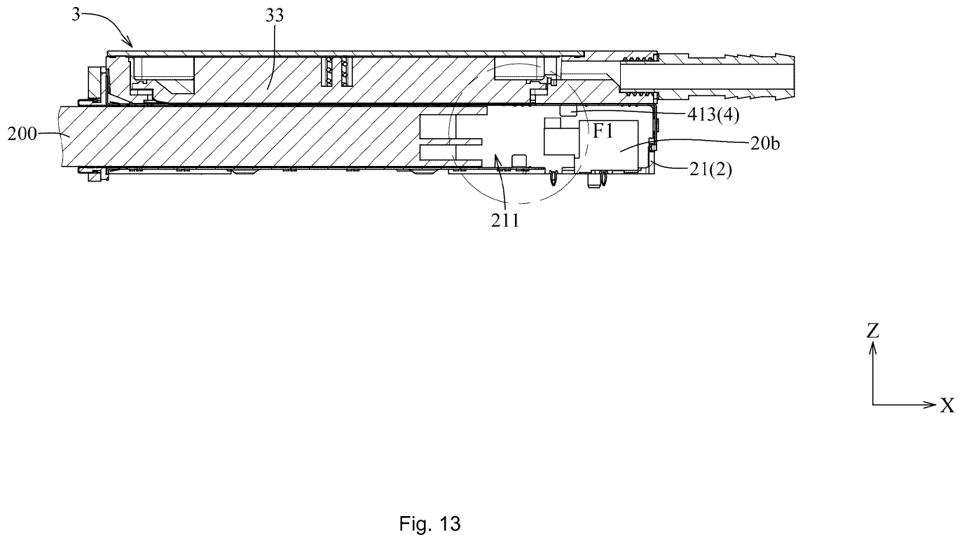

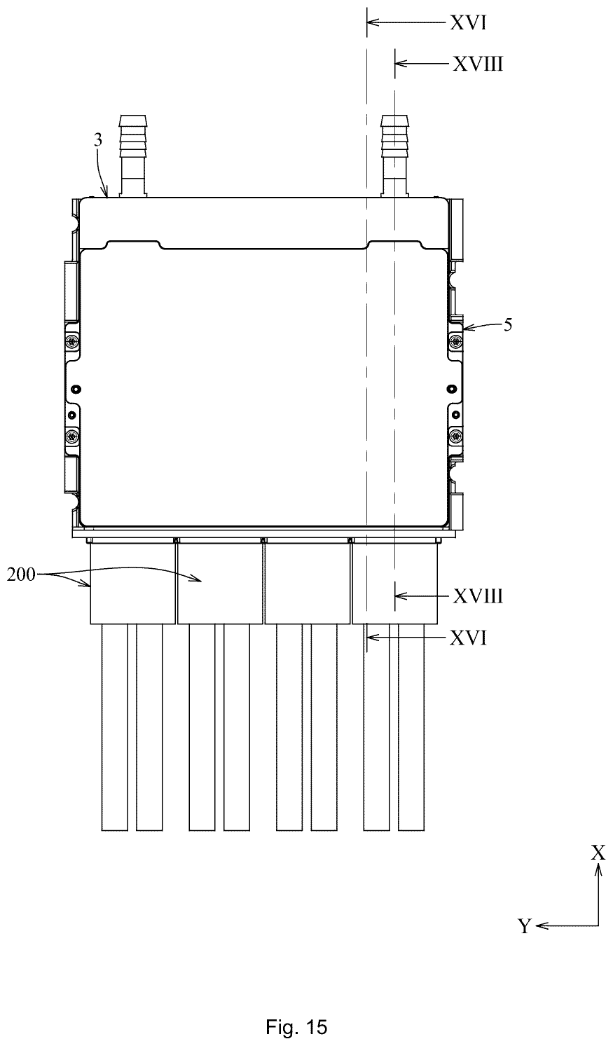

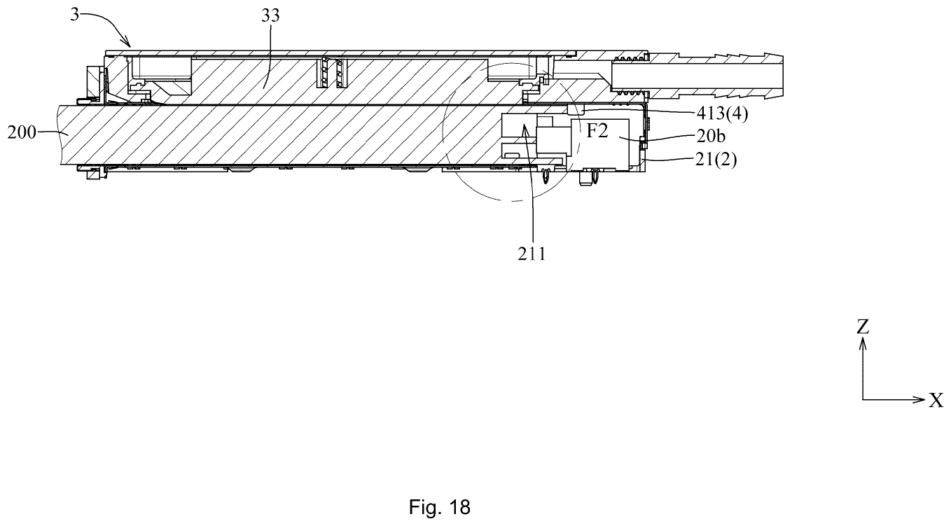

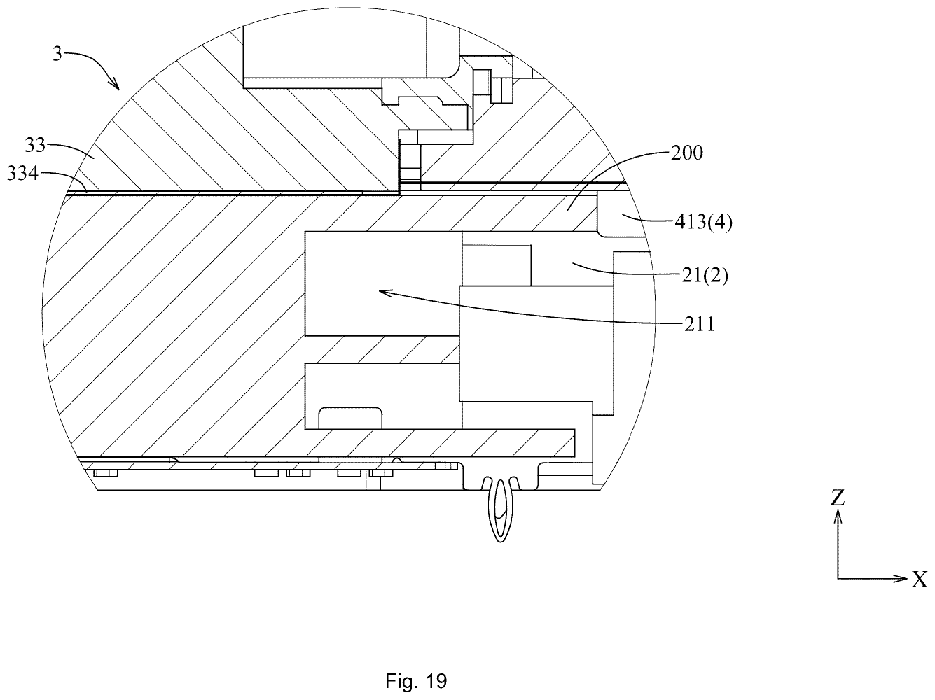

Referring to FIG. 11 to FIG. 19, in a process that the pluggable assembly 200 inserts into the inserting passageway 211, the two actuating members 41 of the slidable mechanism 4 will be simultaneously pushed and moved by the pluggable assembly 200 to bring the heat dissipating base 33 of the heat sink assembly 3 to move so that the heat dissipating base 33 converts from the state that the heat dissipating base 33 is spaced apart from the pluggable assembly 200 as shown in FIG. 14 to a state that the heat dissipating base 33 contacts the pluggable assembly 200 as shown in FIG. 19. Specifically, when the pluggable assembly 200 inserts into the inserting passageway 211 and does not to push the contacting portions 413 of the two actuating members 41, the protruding portions 412 of the two actuating members 41 of the slidable mechanism 4 as shown in FIG. 12 push up two sides of the bottom of the heat dissipating base 33 which each extend along the inserting direction X, so that the heat dissipating base 33 is raised as shown in FIG. 14 to be positioned outside the inserting passageway 211 and be spaced apart from the pluggable assembly 200.

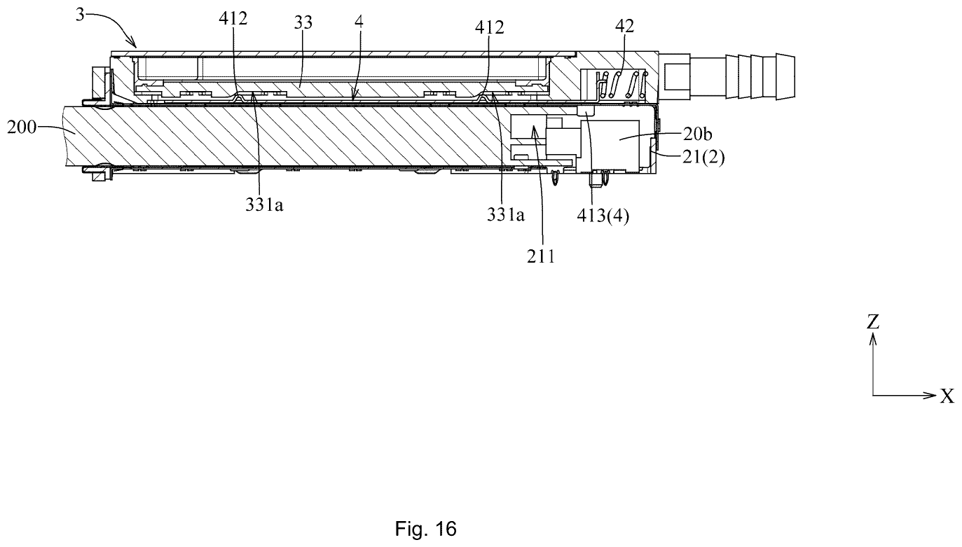

When the pluggable assembly 200 pushes the contacting portions 413 of the two actuating members 41 until the pluggable assembly 200 completely inserts into the inserting passageway 211, the slidable mechanism 4 is pushed to move along the inserting direction X, so that the protruding portions 412 of the two actuating members 41 respectively move into the recessed portions 331a of the heat dissipating base 33 as shown in FIG. 16, which brings the heat dissipating base 33 released and lowered (that is, brings the heat dissipating base 33 move toward the inserting passageway 211) and makes the heat dissipating base 33 partially enter into the inserting passageway 211 to contact the pluggable assembly 200 as shown in FIG. 19. That the two actuating members 41 are simultaneously pushed and moved can make the slidable mechanism 4 move more stably, but in other implementing manners, the slidable mechanism 4 also may only include one actuating member 41 and one elastic member 42, which can be determined as practical requirement.

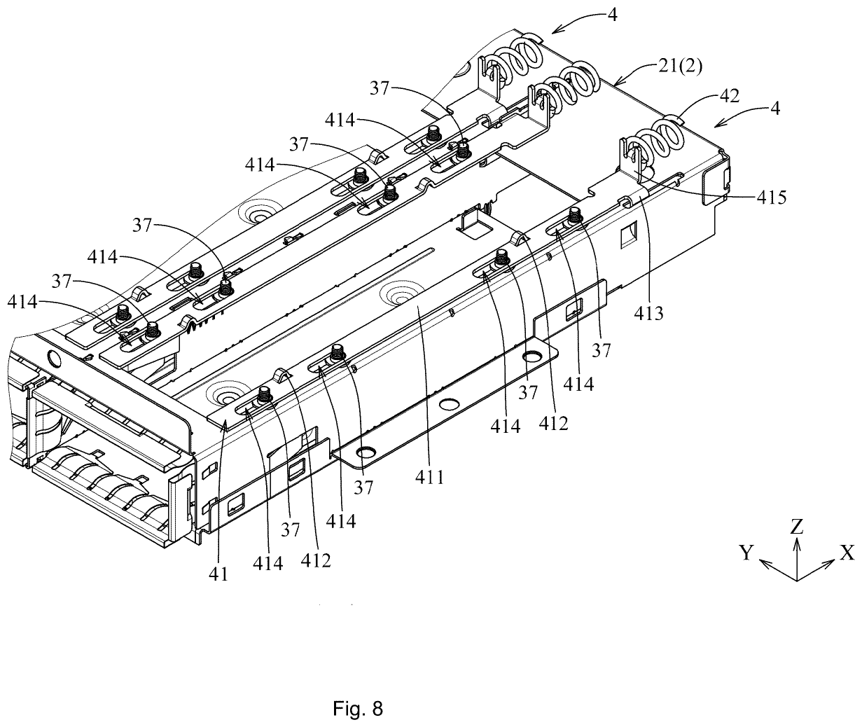

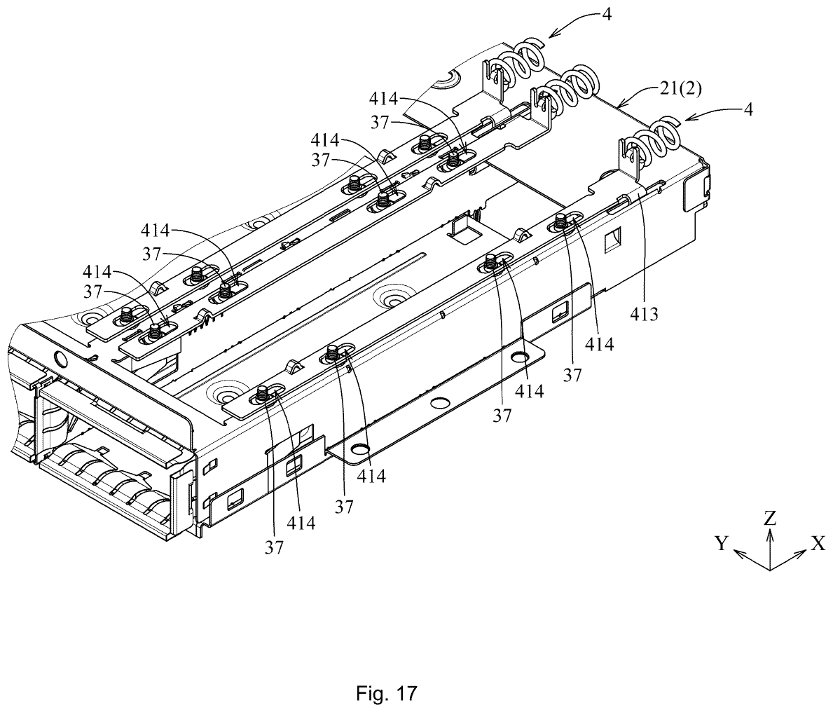

Referring to FIG. 8 and FIG. 17, the heat sink assembly 3 further includes a plurality of position-limiting members 37 which are provided to a bottom surface of the heat sink assembly 3. Preferably, the plurality of position-limiting members 37 are provided to the bottom surface of the main body 32. For example, the position-limiting member 37 is a bolt, but the present invention is not limited thereto. The movable hole 414 is in form of long hole shape and extends along the inserting direction X. The number of the position-limiting members 37 corresponds to the number of the movable holes 414. The movable hole 414 allows the position-limiting member 37 to pass therethrough in a manner that the position-limiting member 37 is capable of moving relative to the movable hole 414 in the inserting direction X. Specifically, as shown in FIG. 8, before the actuating member 41 is not pushed and moved, the position-limiting member 37 passes through a rear side of the movable hole 414; after the actuating member 41 is pushed and moved, the position-limiting member 37 passes through a front side of the movable hole 414 as shown in FIG. 17, as such, it can avoid the actuating member 41 offsetting left and right in a process that the actuating member 41 is moved.

Referring to FIG. 8, FIG. 12 and FIG. 16, the two elastic members 42 are capable of respectively allowing the pressing portions 415 of the two actuating members 41 to press thereagainst to compress lengths thereof. Specifically, when the contacting portions 413 of the two actuating members 41 of the slidable mechanism 4 are pushed and moved by the pluggable assembly 200, the two actuating members 41 of the slidable mechanism 4 (see FIG. 8) move along the inserting direction X to respectively compress the two elastic members 42 as shown in FIG. 16; when the pluggable assembly 200 is pulled out from the inserting passageway 211, the two clastic member 42 are released to restore the lengths thereof and respectively bring the two actuating members 41 to move along a direction opposite to the inserting direction X, so that the slidable mechanism 4 automatically returns to an original position.

In the present embodiment, the number of the protruding portions 412 is two as an example, the two protruding portions 412 push up the heat dissipating base 33 front and rear, which can make the actuating member 41 stably push up the heat dissipating base 33, but the number of the protruding portion 412 also may be only one or three or more, when the number of the protruding portion 412 is one, a top portion of the protruding portion 412 is a plane, which similarly can stably push up the heat dissipating base 33; when the number of the protruding portion 412 is plural, the more the number of the protruding portion 412 is, the more stably the actuating member 41 can push up the heat dissipating base 33. Moreover, the number of the recessed portion 331a corresponds to the number of the protruding portion 412 and similarly is two as an example.

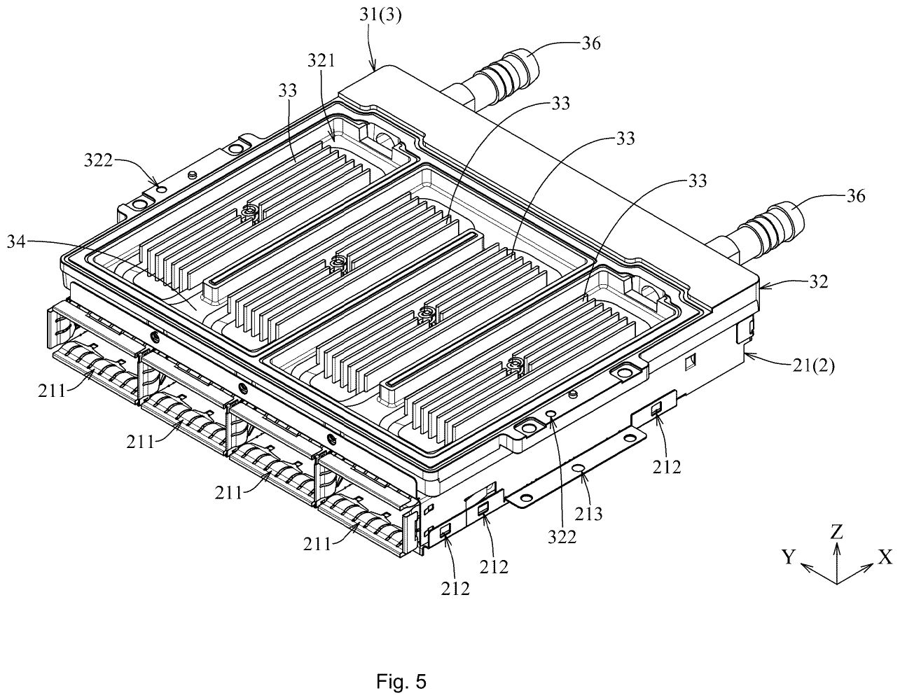

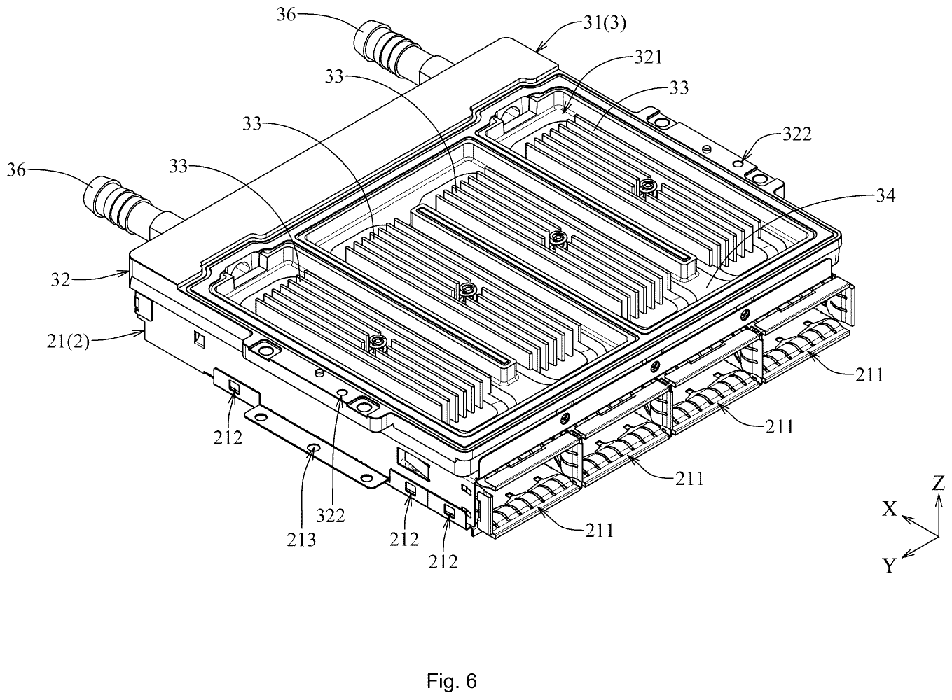

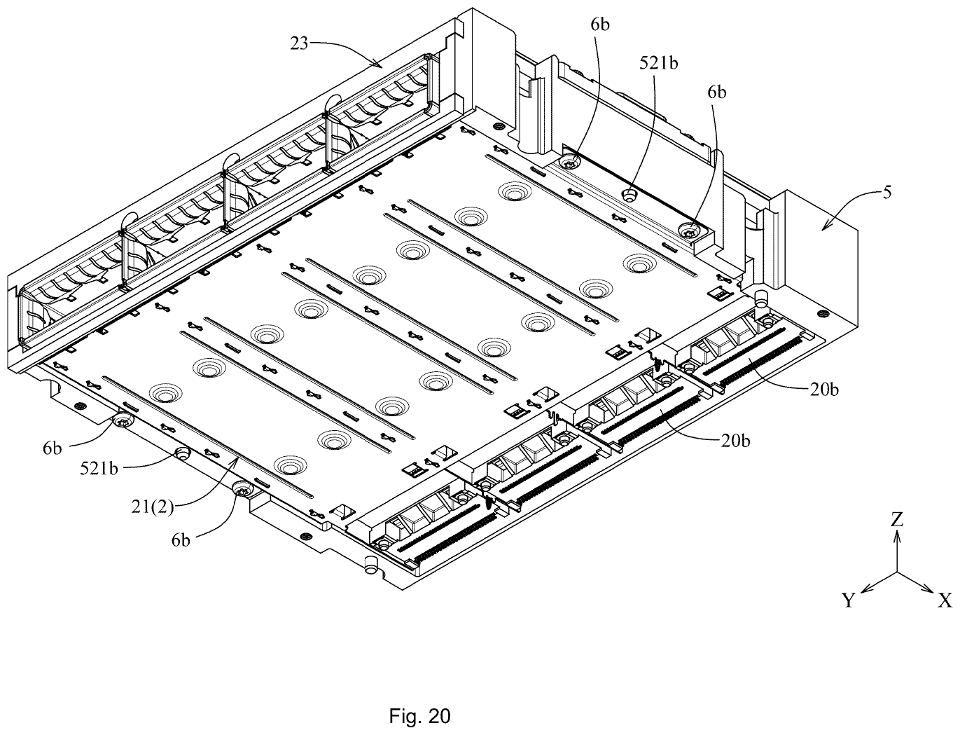

Referring to FIG. 5, FIG. 6 and FIG. 20, the connector assembly 2 further includes an electro-magnetic shielding gasket 23 (EMI gasket) which is positioned on a front side of the metal shell 21. Two sides (that is, a left side and a right side) of the metal shell 21 which each extend along the inserting direction X each are formed with multiple joining holes 212 which are recessed from the metal shell 21. The multiple joining holes 212 are arranged along the inserting direction X. In the present embodiment, the number of the joining hole 212 at each side of the metal shell 21 is three as an example, but the number of the joining hole 212 at each side of the metal shell 21 also may be only one, two or four or more, the present invention is not limited to the specific number.

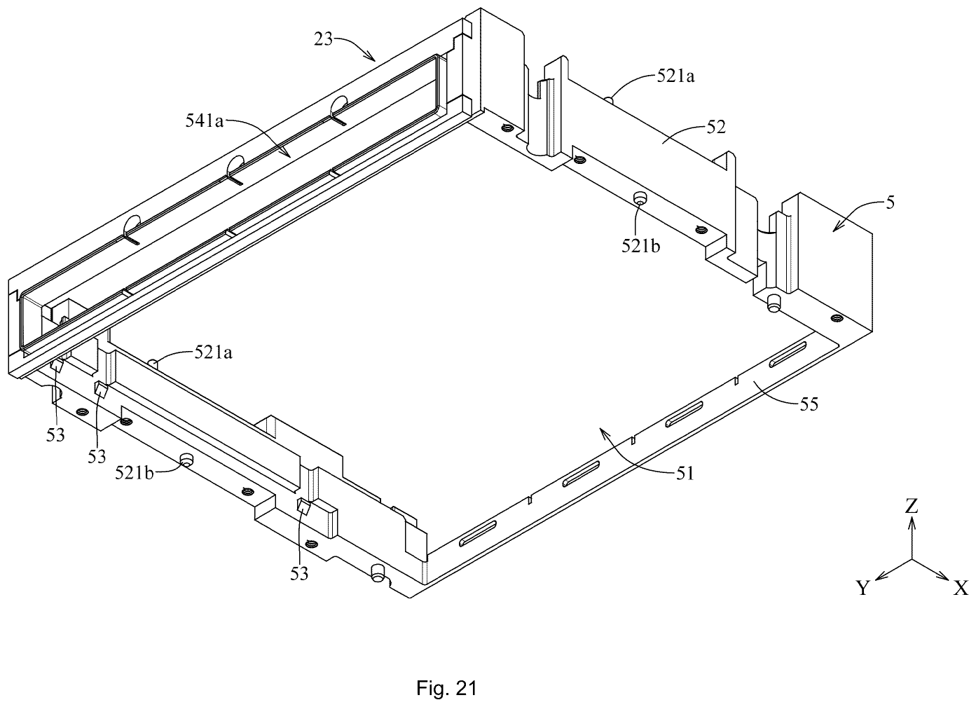

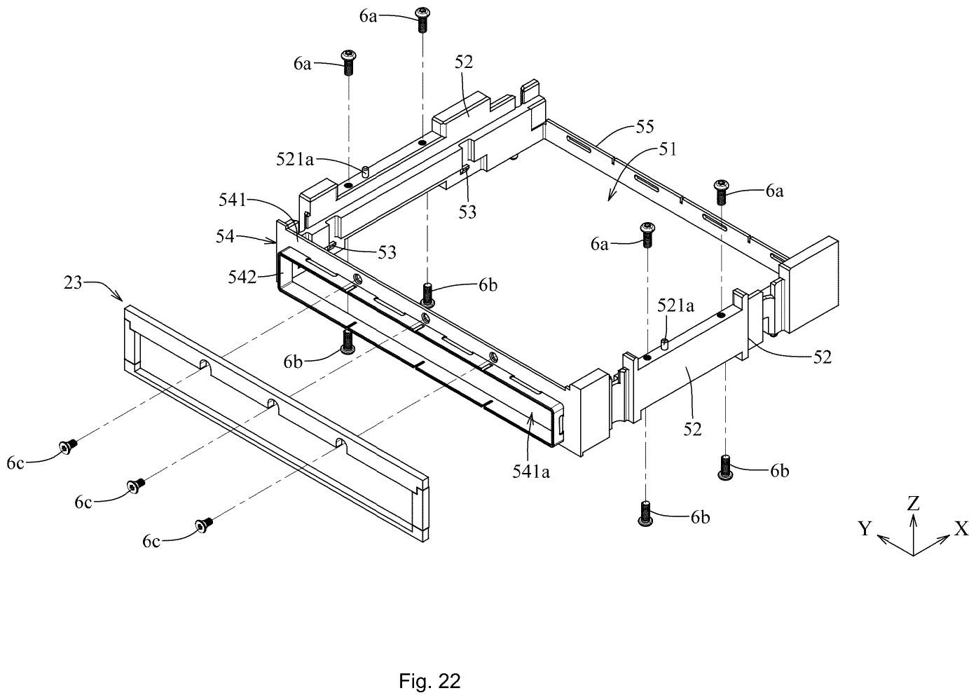

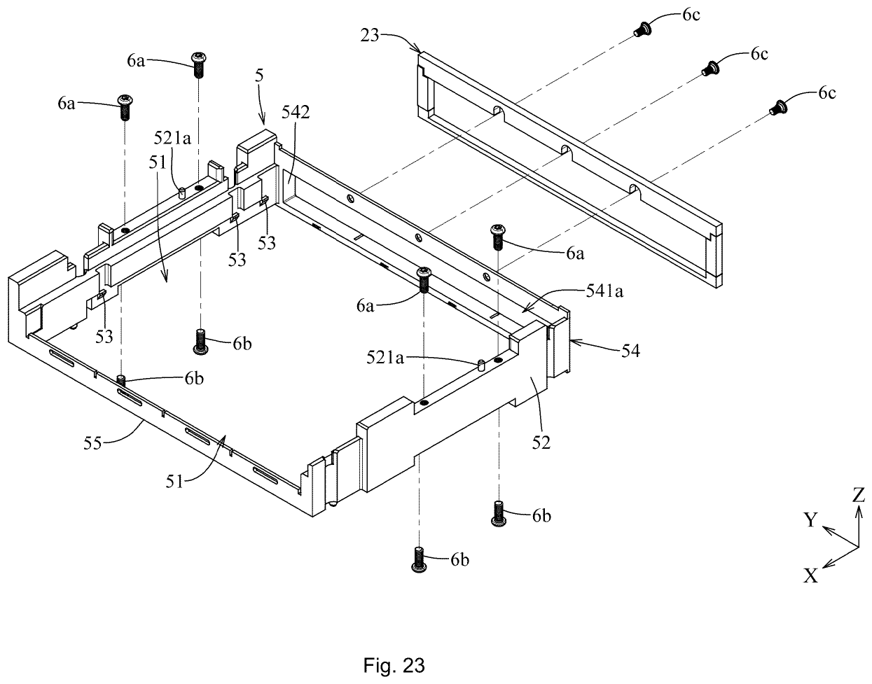

Referring to FIG. 2 and FIG. 20 to FIG. 23, the bracket 5 surrounds the metal shell 21 and is mounted to the metal shell 21 and is used to support the cold plate 31. A top portion of the bracket 5 and a top portion of the metal shell 21 together define a receiving space 51. The receiving space 51 allows the cold plate 31 to be placed therein. Specifically, the bracket 5 includes two bracket side walls 52 which each extend along the inserting direction X, a plurality of joining members 53 which are respectively provided to inner sides of the two bracket side walls 52 and the number of which corresponds to the number of the joining holes 212, a bracket front wall 54 whose a left side and a right side are respectively connected to front sides of the two bracket side walls 52, and a bracket rear wall 55 whose a left side and a right side are respectively connected to rear sides of the bracket side wall 52. The bracket front wall 54 has a front wall main body 541 and a front extending portion 542.

The two bracket side walls 52 respectively attach on the left side and the right side of the metal shell 21 and top portions of the two bracket side walls 52 push up a left side and a right side of the cold plate 31 to support the cold plate 31. The front wall main body 541 is formed with a front side opening 541a which passes through the front wall main body 541 front and rear and allows the front side of the metal shell 21 to pass therethrough. The front extending portion 542 extends forwardly from a periphery of the front side opening 541a, and passes through the electro-magnetic shielding gasket 23. The plurality of joining members 53 of the bracket 5 respectively removably insert into the joining holes 212, so that the bracket 5 is firmly mounted to the connector assembly 2. In the present embodiment, a material of the bracket 5 may be a metal or a plastic plated with an electrical conductive layer, which is electrical conductive, and the bracket 5 contacts the electro-magnetic shielding gasket 23 to attain the electro-magnetic shielding effect. But in other implementing manners, the electro-magnetic shielding gasket 23 may be omitted, at this time, the material of the bracket 5 may be an electrical conductive metal or an insulative plastic.

Referring to FIG. 2, FIG. 5, FIG. 6 and FIG. 20 to FIG. 23, preferably, the cold plate 31 and the two bracket side walls 52 of the bracket 5 are locked by multiple screws 6a (taking four screws 6a as an example) from up to down, as such, connection between the cold plate 31 and the bracket 5 can be firmer. Preferably, a bottom plate of the metal shell 21 and a left side and a right side of the bracket 5 are locked by other multiple screws 6b (taking other four screws 6b as an example) from down to up, as such, connection between the connector assembly 2 and the bracket 5 can be firmer. Preferably, a front side of the cold plate 31 and the bracket 5 are locked by still other multiple screws 6c (taking still other three screws 6c as an example) from front to rear, as such, connection between the cold plate 31 and the bracket 5 also can be firmer. Moreover, the bracket 5 can be further locked to the circuit board 1 by four screws 6d from down to up as shown in FIG. 2. Preferably, the main body 32 further has two main body positioning holes 322 which are respectively positioned at a left side and a right side of the main body 32. The metal shell 21 further has two shell positioning holes 213 which are respectively positioned at a left side and a right side of the metal shell 21. Each bracket side wall 52 further has a first protruding post 521a which extends upwardly from a top side of the bracket side wall 52 and a second protruding post 521b which extends downwardly from a bottom side of the bracket side wall 52. In a process that the bracket 5, the connector assembly 2 and the cold plate 31 are assembled, the first protruding posts 521a respectively pass through the main body positioning holes 322 and the second protruding posts 521b respectively pass through the shell positioning holes 213, so as to attain an effect of guiding and positioning.

In conclusion, by that the slidable mechanism 4 is movably provided to the cold plate 31, in a process that the pluggable assembly 200 inserts into the inserting passageway 211, firstly the heat dissipating base 33 is spaced apart from the pluggable assembly 200 to prevent friction between the heat dissipating base 33 and the pluggable assembly 200 to damage the heat dissipating base 33, and when the pluggable assembly 200 which inserts into the inserting passageway 211 pushes and moves the slidable mechanism 4, the heat dissipating base 33 still can thermally engage with the pluggable assembly 200, in turn an effect of promoting durability is attained. In another aspect, by that the cold plate 31 is fixed to the metal shell 21 via the bracket 5, a weight per unit area applied to the metal shell 21 by the cold plate 31 can be dispersed, which avoids the metal shell 21 being deformed due to bearing the weight, and by that the receiving space 51 allows the cold plate 31 to be placed therein, the cold plate 31 can be limited by the bracket 5 so that the cold plate 31 cannot move front, rear, left and right, in turn an effect of firmly and effectively fixing is attained. Preferably, the bracket 5 is locked with the cold plate 31 and/or the metal shell 21 by the screws, firmness of the bracket 5 can be promoted, so the object of the present invention can be indeed realized.

However, the above description is only for the embodiment of the present invention, and it is not intended to limit the implementing scope of the present invention, and the simple equivalent changes and modifications made according to the claims and the contents of the specification are still included in the scope of the present invention.

What is claimed is:

1. A connection device, comprising:
a connector assembly comprising an inserting passageway which allows a pluggable assembly to insert therein along an inserting direction; and
a heat sink assembly provided outside the connector assembly and comprising a cold plate and a slidable mechanism, the cold plate having a main body and a heat dissipating base, the main body being used to allow a cooling liquid to flow in an interior of the main body, the heat dissipating base being capable of floating relative to the main body and being used to thermally engage with the pluggable assembly, the slidable mechanism being movably provided to the cold plate, and a part of the slidable mechanism extending into the inserting passageway and being capable of allowing the pluggable assembly to push, in a process that the pluggable assembly inserts into the inserting passageway, the slidable mechanism being pushed and moved by the pluggable assembly to bring the heat dissipating base to move so that the heat dissipating base converts from a state that the heat dissipating base is spaced apart from the pluggable assembly to a state that the heat dissipating base contacts the pluggable assembly.

2. The connection device of claim 1, wherein
two sides of a bottom of the heat dissipating base which each extend along the inserting direction each are provided with a recessed portion;
the slidable mechanism comprises two actuating members which are movably provided to the cold plate, each actuating member has a protruding portion which extends toward the heat dissipating base and a contacting portion which extends into the inserting passageway and is capable of allowing the pluggable assembly to push.

3. The connection device of claim 2, wherein
when the contacting portions of the two actuating members of the slidable mechanism are not pushed by the pluggable assembly, the protruding portions of the two actuating members of the slidable mechanism push up the two sides of the bottom of the heat dissipating base, which each extend along the inserting direction, to make the heat dissipating base spaced apart from the pluggable assembly;
when the contacting portions of the two actuating members of the slidable mechanism are pushed and moved by the pluggable assembly, the protruding portions of the two actuating members respectively move into the two recessed portions of the heat dissipating base, which brings the heat dissipating base to move toward the inserting passageway so that the heat dissipating base contacts the pluggable assembly.

4. The connection device of claim 3, wherein
the slidable mechanism further comprises two elastic members which are capable of respectively allowing the two actuating members to press thereagainst so that the two elastic members are compressed,
when the contacting portions of the two actuating members of the slidable mechanism are pushed and moved by the pluggable assembly, the two actuating members of the slidable mechanism move along the inserting direction to respectively compress the two elastic members;
when the pluggable assembly is pulled out from the inserting passageway, the two elastic members are released to restore lengths thereof to respectively bring the two actuating members to move along a direction opposite to the inserting direction.

5. The connection device of claim 2, wherein
the heat sink assembly further comprises two position-limiting members which are provided to a bottom surface of the main body,
each actuating member further has a movable hole which passes through an upper surface and a lower surface of the actuating member and extends along the inserting direction, the movable holes of the two actuating members respectively allow the two position-limiting members to pass therethrough in a manner that the two position-limiting members are capable of respectively moving relative to the movable holes in the inserting direction.

6. The connection device of claim 1, wherein
the two sides of a bottom of the heat dissipating base which each extend along the inserting direction each are provided with two recessed portions are arranged along the inserting direction;
the slidable mechanism comprises two actuating members which are movably provided to the cold plate, each actuating member has two protruding portions which extend toward the heat dissipating base and are arranged along the inserting direction, and a contacting portion which extends into the inserting passageway and is capable of allowing the pluggable assembly to push,
when the contacting portions of the two actuating members of the slidable mechanism are not pushed by the pluggable assembly, the four protruding portions of the two actuating members of the slidable mechanism respectively push up four positions of the bottom of the heat dissipating base to make the heat dissipating base spaced apart from the pluggable assembly;
when the contacting portions of the two actuating members of the slidable mechanism are pushed and moved by the pluggable assembly, the two protruding portions of the two actuating members respectively move into the four recessed portions of the heat dissipating base, which brings the heat dissipating base to move toward the inserting passageway so that the heat dissipating base contacts the pluggable assembly.

7. A connection device, comprising:
a connector assembly comprising an inserting passageway which allows a pluggable assembly to insert therein along an inserting direction; and
a heat sink assembly provided outside the connector assembly and comprising a heat dissipating base and a slidable mechanism, the heat dissipating base being used to thermally engage with the pluggable assembly, the slidable mechanism being movably provided to the heat sink assembly, and a part of the slidable mechanism extending into the inserting passageway and being capable of allowing the pluggable assembly to push, in a process that the pluggable assembly inserts into the inserting passageway, the slidable mechanism being pushed and moved by the pluggable assembly to bring the heat dissipating base to move so that the heat dissipating base converts from a state that the heat dissipating base is spaced apart from the pluggable assembly to a state that the heat dissipating base contacts the pluggable assembly.

8. The connection device of claim 7, wherein
two sides of a bottom of the heat dissipating base which each extend along the inserting direction each are provided with a recessed portion;
the slidable mechanism comprises two actuating members which are movably provided to the heat sink assembly, each actuating member has a protruding portion which extends toward the heat dissipating base and a contacting portion which extends into the inserting passageway and is capable of allowing the pluggable assembly to push.

9. The connection device of claim 8, wherein
when the contacting portions of the two actuating members of the slidable mechanism are not pushed by the pluggable assembly, the protruding portions of the two actuating members of the slidable mechanism push up the two sides of the bottom of the heat dissipating base, which each extend along the inserting direction, to make the heat dissipating base spaced apart from the pluggable assembly;
when the contacting portions of the two actuating members of the slidable mechanism are pushed and moved by the pluggable assembly, the protruding portions of the two actuating members respectively move into the two recessed portions of the heat dissipating base, which brings the heat dissipating base to move toward the inserting passageway so that the heat dissipating base contacts the pluggable assembly.

10. The connection device of claim 9, wherein
the slidable mechanism further comprises two elastic members which are capable of respectively allowing the two actuating members to press thereagainst so that the two elastic members are compressed,
when the contacting portions of the two actuating members of the slidable mechanism are pushed and moved by the pluggable assembly, the two actuating members of the slidable mechanism move along the inserting direction to respectively compress the two elastic members;
when the pluggable assembly is pulled out from the inserting passageway, the two elastic members are released to restore lengths thereof to respectively bring the two actuating members to move along a direction opposite to the inserting direction.

11. The connection device of claim 8, wherein
the heat sink assembly further comprises two position-limiting members which are provided to the heat sink assembly,
each actuating member further has a movable hole which passes through an upper surface and a lower surface of the actuating member and extends along the inserting direction, the movable holes of the two actuating members respectively allow the two position-limiting members to pass therethrough in a manner that the two position-limiting members are capable of respectively moving relative to the movable holes in the inserting direction.

12. The connection device of claim 8, wherein
the two sides of a bottom of the heat dissipating base which each extend along the inserting direction each are provided with two recessed portions are arranged along the inserting direction;
each actuating member has two protruding portions which extend toward the heat dissipating base and are arranged along the inserting direction, and a contacting portion which extends into the inserting passageway and is capable of allowing the pluggable assembly to push,
when the contacting portions of the two actuating members of the slidable mechanism are not pushed by the pluggable assembly, the four protruding portions of the two actuating members of the slidable mechanism respectively push up four positions of the bottom of the heat dissipating base to make the heat dissipating base spaced apart from the pluggable assembly;
when the contacting portions of the two actuating members of the slidable mechanism are pushed and moved by the pluggable assembly, the two protruding portions of the two actuating members are respectively moved into the four recessed portions of the heat sink assembly, which brings the heat sink assembly to move toward the inserting passageway so that the heat sink assembly contacts the pluggable assembly.

13. A connection device, comprising:
a connector assembly comprising a metal shell, the metal shell providing an inserting passageway which allows a pluggable assembly to insert therein along an inserting direction;
a cold plate positioned above the connector assembly and used to thermally engage with the pluggable assembly; and
a bracket mounted to the metal shell and used to support the cold plate, a top portion of the bracket and a top portion of the metal shell together defining a receiving space, the receiving space allowing the cold plate to be placed therein.

14. The connection device of claim 13, wherein
a material of the bracket is an electrical conductive metal or an insulative plastic.

15. The connection device of claim 13, wherein
the connector assembly further comprises an electro-magnetic shielding gasket which is positioned on a front side of the metal shell,
the bracket contacts the electro-magnetic shielding gasket, and a material of the bracket is a metal or a plastic plated with an electrical conductive layer, which is electrical conductive.

16. The connection device of claim 13, wherein
the cold plate and the bracket are locked together by screws.

17. The connection device of claim 13, wherein
the connector assembly and the bracket are locked together by screws.

18. The connection device of claim 13, wherein
two sides of the metal shell which each extend along the inserting direction each are formed with multiple joining holes which are recessed from the metal shell;
the bracket comprises two bracket side walls which each extend along the inserting direction and a plurality of joining members which are respectively provided to inner sides of the two bracket side walls,
the plurality of joining members removably insert into the joining holes respectively so that the bracket is mounted to the connector assembly.
